(19) United States
(12) Patent Application Publication
(10) Pub. No.: US 2003/0069745 A1
(43) Pub. Date: Apr. 10, 2003

(54) Waste collection system and method thereof

(76) Inventor: Hideaki Zenko, Kanagawa (JP)

Correspondence Address: MORGAN & FINNEGAN, L.L.P., 345 PARK AVENUE, NEW YORK, NY, 10154, US

(21) Appl. No.: 10/245,478

(22) Filed: Sep. 17, 2002

(30) Foreign Application Priority Data
Sep. 20, 2001 (JP) 286543/2001 (PAT.

(51) Int. Cl. G06F 17/60

(52) U.S. Cl. 705/1

(57) ABSTRACT

The invention of the present application provides a system for efficiently collecting general consumer oriented products such as used electric/electrical products, OA appliances etc.

Related sectors for manufacturing and selling products and collecting and processing wastes thereof and a local government share information about the wastes with each other via a network, and an efficient waste collection/conveyance method is determined based on the information about the waste that is transmitted by a disposal person. Further, the related sectors for manufacturing and selling products and collecting and processing wastes thereof and the local government share the information about the wastes with each other via the network, thereby configuring the system capable of confirming a waste processing state, wherein the waste processing is grasped and monitored.

### BACKGROUND OF THE INVENTION

1. Field of the Invention

The present invention relates generally to a waste collection system for recycling and reusing wastes of electric products, home electric appliances, OA appliances etc utilized on the market, and more particularly to a system capable of efficiently collecting the waste products at a lost cost by utilizing an infrastructure for transportation for a physical distribution and an infrastructure for information. Further, the present invention provides a system required for promotions of building the recycling-oriented society and of reducing an environmental load.

2. Related Background Art

With an advancement of the technological development, a multiplicity of OA appliances, automobiles, home electric appliances, electric/electrical products were distributed on the market, and those products brought about the rapid economical growth and were stimuli for improvements in human life in the 20th century. In the second half of the 20th century, however, the industrial and livelihood products, which have brought about a great deal of enjoyments to us, now present as a huge problem as the destruction of the global environment. Further, under the circumstances where the exhaustion of the natural resources gives an alarm to us, a mass consumption of those products that gave us affluence led to a mass consumption of the natural resources. Then, there arise problems causing adverse influences such as a deficiency of waste processing places for processing those waste, the environmental destruction caused by toxic chemical substances etc discharged from the waste processing products, and damages to health of the human bodies.

Nowadays, the recycling processing of the waste processing products is carried out and examined in a variety of forms, wherein the local governments and waste processing business agencies recycle metals such as iron, aluminum, stainless steel etc and plastic materials.

An amount of these recycling object members is, however, just small, and the reuse system for the parts etc is not yet established as a well-spread recycling system. Further, a processing method taken now is that a large proportion of products are directly discarded without through the recycling system, and the great majority of wastes are broken into fragments and thrown in an as-broken form or thrown after incineration processing to reclaim a land of wastes.

Therefore, in spite of promoting the recycling, there occur problems such as a deficiency of the reclaimed lands for disposal, an illegal disposal of the wastes, land and water pollution caused by the toxic substances discharged due to the land reclamation. Further problems arise, such as the air pollution caused by efflux of a toxic gas like dioxin evolved at the incineration and the greenhouse effect of the earth due to an occurrence of CO₂.

For obviating these problems, the mass-production/mass-consumption oriented economic structure is demanded for reconstruction into a recycling-oriented economic social structure in which the recycling is the core. What is given as a subject is a responsible collection of the used products by each maker and the recycling thereof.

In such a situation, [Specific Home Appliance Re-commercialization Lay (Home Electrical Appliance Recycling Lay)] was proclaimed in June, 1998 and enforced from April in 2001 in Japan. According to this law, with respect to the object appliances designated by the government ordinance, the manufacturers etc are obligated to [take back and recycle (re-commercialize)] these appliances, the retailers are obligated to [take back the appliances from disposal persons and transfer them to the manufacturers], the disposal person is obligated to [transfer the appliances and pay a recycling fee], thus sharing these roles with each other and promoting the recycling. The object appliances are required to be those that are difficult for the local government to re-commercialize (1), exhibit particularly a high necessity of re-commercialization (2), have an important influence of design and selection of the parts upon the re-commercialization (3), and are irrational of collection by the retailers because of their being delivery articles. Four items of home electrical appliances such as a TV set, a refrigerator, a washing machine and an air-conditioner are designated as the items meeting those conditions in December, 1998. What can be considered as a system operation for the Home Electric Appliance Recycling Law is a system as shown in FIG. 1. Further, a fee collecting method based on a home appliance recycling ticket shown in FIG. 1 is categorized into two systems such as a [sales shop collection system] and a [financial institution payment system], and this home appliance recycling ticket serves as a role of a management table (a manifest slip). This management table serves to prevent improper processing such as an illegal disposal of the waste and so on. This is known as a manifest system and one of policies, wherein the government and municipal offices strengthen mainly the designation of the waste processing business agencies and the management of the waste disposal process.

The reference numeral 11 represents a disposal person (consumer), 12 designates a financial institution, 13 stands for a retailer, 14 indicates a home appliance recycling ticket center (RKC), 15 represents a designated collation place, 16 shows a manufacturer (maker), and 17 stands for a re-commercialization facility or manufacturer (maker). Further, an arrowhead 18 indicates a home appliance recycling ticket, 19 represents a re-commercialization fee, 110 shows specified household appliance wastes (four items), 111 designates collection information, and 112 indicates a flow of collection/conveyance fee.

The system shown in FIG. 1 can not necessarily be, though it might function, said to be an efficient system.

The reason is, firstly, that the retailer 13 exists between the disposal person (consumer) 11 discarding the waste and the manufacturer 16 at which the waste arrives, and hence management costs for a preservation space, a sorting management etc are needed on the side of the retailer 13 in addition to a cost for a physical distribution, with the result that the disposal person and the retailer each have a large burden. This is a serious problem especially to the retailer having no physical distribution system.

Secondly, two categories of recycling fee collecting methods exist, and the system thereof is not easily understandable to the disposal person, resulting in a possibility of causing a confusion.

Thirdly, the home appliance recycling ticket is used for ensuring a secured transportation of the waste of the object appliance, however, if this item of waste will spread in the future, an amount of the wastes becomes tremendous, and it is therefore presumed that an issuance amount of the home appliance tickets increases. In such a case, it is considered that there increase the management costs for managing and operating the home appliance recycling tickets.

Fourthly, there is not yet configured a system for quickly precisely informing related institutions such as the manufacturers etc of the recycling information (an amount of collection, a name of product etc). A further problem is that there be ensured a space for preserving the discarded home appliances collected.

Fifthly, the home appliance recycling ticket center 14 is provided for the efficient operation, however, a manpower cost related to this center 14 occurs, and hence there is a possibility in which this cost leads to a rise in burden upon the disposal person.

Since the problems described above are considered, it can not necessarily be said that the system as shown in FIG. 1 is an efficient system.

Moreover, the system in FIG. 1 is the system pursuant to the Home Appliance Recycling Lay, and the collection object appliances are limited to the four items of home appliances such as the TV set, the refrigerator, the washing machine and the air-conditioner. The recycling object appliances might be expanded in their categories in the future, and all the electric home appliances need recycling in terms of recycling. According to the system in FIG. 1, however, the costs for efficiently collecting and managing the electric home appliance products containing a tremendous number of product groups become, it is considered, larger than the four items of home appliances such as the TV set, the refrigerator, the washing machine and the air-conditioner, and therefore a more efficient system is desired.

Moreover, the collection object appliances in the system shown in FIG. 1 are the our items of home appliances such as the TV set, the refrigerator, the washing machine and the air-conditioner and are delivery articles mainly when purchasing them. Their collections are rationally conducted by the retailers, however, in the case of collecting the articles that are not the delivery articles when purchased or appliances discarded for a purpose other than newly purchasing, the disposal person is required to inform directly the retailer or to delivery it directly to the retailer. This is not rational. In this case, a burden might be imposed on the disposal person, which might be an obstacle against spreading the recycling system.

Under such circumstances, there are made several proposals related to the recycling system for obviating the problems described above. For example, Japanese Patent Application Laid-Open No. 5-342224 describes a technique for controlling, managing and scheming a transportation of waste to a recycling means from a preserving means by grasping an amount of the wastes of the preserving means and the recycling means on the basis of a specified item of waste information in a way that uses barcodes etc. Japanese Patent Application Laid-Open No. 5-342224 neither, however, describes a specific method of collecting the waste from general consumers who discard the wastes directly into the society nor functions as a system till the wastes are collected from the disposal persons by a secured method.

Further, Japanese Patent Application Laid-Open No. 11-268803 describes a system for preventing the illegal disposal of the waste home appliances. This system is capable of promoting the recycling in safety, however, there is no description of an essential and specific efficient method for collecting the waste home appliances.

Moreover, according to Japanese Patent Application Laid-Open No. 2000-263024, an information writable/readable ID tag is attached to a waste product such as an automobile, a home appliance etc discarded by the consumer, and pieces of recycling information such as a name of maker of the waste product, a product number, a decomposing method, a transportation route, and a name and an address of a consumer, are thus one-dimensionally managed, thereby making it possible to prevent the illegal disposal and illegal selling of the waste product and to efficiently manage the recycling. A specific means for collecting the waste product discarded by the consumer is not, however, described therein.

Furthermore, Japanese Patent Application Laid-Open No. 2000-276049 describes a waste collection processing system for managing the waste information in the form of a management slip and is characterized mainly by giving various items of information to the management slip, but does not describe a system for collecting the wastes from the consumer/disposal person.

Japanese Patent Application Laid-Open No. 8-194898 describes a proposal of a specific method for collecting the wastes. This method schemes to effectively utilize a conveyance vehicle used for delivering a product and collecting a waste product by determining an optimal circulation pattern of the vehicle for delivering the product. To be specific, in the case of loading the delivery vehicle with a delivery product produced at a production factory and delivering it to a selling shop, the vehicle is empty of its load-carrying platform on a returning road and decreases in efficiency. According to Japanese Patent Application Laid-Open No. 8-194898, a delivery collection system enables the vehicle empty of its load-carrying platform on the returning road to collect the waste.

This system, however, includes not a method of processing desires/needs information about the waste product that is to be discarded by the consumer/disposal person, but mainly a method of making the conveyance vehicle collect effectively the waste product collected by the selling shop from the disposal person. This system does not therefore show any approach to the waste collecting request of the individual consumer/disposal person, the preservation problem of the selling shop and the multiple waste product groups.

Further, the present situation of the waste collection method is that when collecting the wastes such as the electric products, the home appliances etc discarded from the general consumers, i.e., the households, other than the system shown in FIG. 1, the wastes are collected in such a system that the consumer notifies the local government and the waste is collected on a designated collection date, wherein the waste is not collected on a date convenient to the consumer. Further, with respect to the waste collection method, as described above, there is not yet established a system capable of flexibly corresponding to a variety of events.

### SUMMARY OF THE INVENTION

It is a primary object of the present invention to establish a method of efficiently collecting a waste discarded by a general consumer, and also a monitoring means.

To accomplish the above object, according to one aspect of the present invention, a waste collection system for collecting a waste comprises a terminal of a waste collection center for managing at least information about a waste to be collected, a terminal of a collection and delivery center for managing a conveyance vehicle for collecting the waste, a terminal of the conveyance vehicle for collecting the waste, a terminal of a designated collection place for receiving the waste, and a terminal of a recycling processing facility for processing the waste, the terminals sharing a waste management database with each other via a network, the waste management database containing the information about the waste, and the terminal of the waste collection center includes recognition means for recognizing that a disposal person who disposes of the waste transmits the waste information by use of communication means, and storage collation means for storing the waste information in the waste management database and/or collating the waste information with the waste management database, wherein the collection and delivery center for collecting the waste, the conveyance vehicle and the designated collection place or the recycling processing facility to which the conveyance vehicle carries the waste, are selected within the waste management database.

According to another aspect of the present invention, a waste collection system for collecting a waste comprises a terminal of a waste collection center for managing at least information about a waste to be collected, a terminal of a collection and delivery center for managing a conveyance vehicle for collecting the waste, a terminal of the conveyance vehicle for collecting the waste, a terminal of a designated collection place for receiving the waste, and a terminal of a recycling processing facility for processing the waste, the terminals sharing a waste management database with each other via a network, the waste management database containing the information about the waste, wherein the terminal of the waste collection center, includes storage collation means for storing waste information in the waste management database and/or collating the waste information with the waste management database in order to create a waste collection management table, the terminal of the collection and delivery center or the conveyance vehicle, includes first input means for inputting first collection information of the waste to the waste collection management table when collecting the waste, one terminal selected among the terminals of at least the conveyance vehicle, the designated collection place and the recycling processing facility, includes second input means for inputting second collection information of the waste to the waste collection management table when the conveyance vehicle carries the waste to the designated collection place or the recycling processing facility, and the terminal of the recycling processing facility includes third input means for inputting recycling processing end information to the waste collection management table when finishing the recycling processing of the waste.

According to still another aspect of the present invention, there is provided a waste collection method in a system comprising a terminal of a waste collection center for managing at least information about a waste to be collected, a terminal of a collection and delivery center for managing a conveyance vehicle for collecting the waste, a terminal of the conveyance vehicle for collecting the waste, a terminal of a designated collection place for receiving the waste, and a terminal of a recycling processing facility for processing the waste, the terminals sharing a waste management database with each other via a network, the waste management database containing the information about the waste, the terminal of the waste collection center including a recognition step of recognizing that a disposal person who disposes of the waste transmits the waste information by use of communication means, and a storage collation step of storing the waste information in the waste management database and/or collating the waste information with the waste management database, wherein the collection and delivery center for collecting the waste, the conveyance vehicle and the designated collection place or the recycling processing facility to which the conveyance vehicle carries the waste, are selected within the waste management database.

According to a further aspect of the present invention, there is provided a waste collection method in a system comprising a terminal of a waste collection center for managing at least information about a waste to be collected, a terminal of a collection and delivery center for managing a conveyance vehicle for collecting the waste, a terminal of the conveyance vehicle for collecting the waste, a terminal of a designated collection place for receiving the waste, and a terminal of a recycling processing facility for processing the waste, the terminals sharing a waste management database with each other via a network, the waste management database containing the information about the waste, wherein the terminal of the waste collection center, includes a storage collation step of storing waste information in the waste management database and/or collating the waste information with the waste management database in order to create a waste collection management table, the terminal of the collection and delivery center or the conveyance vehicle, includes a first input step of inputting first collection information of the waste to the waste collection management table when collecting the waste, one terminal selected among the terminals of at least the conveyance vehicle, the designated collection place and the recycling processing facility, includes a second input step of inputting second collection information of the waste to the waste collection management table when the conveyance vehicle carries the waste to the designated collection place or the recycling processing facility, and the terminal of the recycling processing facility includes a third input step of inputting recycling processing end information to the waste collection management table when finishing the recycling processing of the waste.

### BRIEF DESCRIPTION OF THE DRAWINGS

FIG. 1 is a diagram showing one operational example of a system based on the Home Electric Appliance Recycling Law;

FIG. 2 is a schematic diagram showing one example of a waste collection method to which a waste collection system in an embodiment of the present invention is applied;

FIG. 3 is comprised of FIGS. 3A and 3B showing conceptual diagrams for explaining one example of the waste collection system for determining the waste collection method and a waste conveyance method from waste information and a waste management database in this embodiment;

FIG. 4 is comprised of FIGS. 4A, 4B and 4C showing diagrams for explaining one example of steps for grasping and monitoring a collection state, a conveyance state and a processing state of the waste;

FIG. 5 is comprised of FIGS. 5A, 5B and 5C showing diagrams for explaining one example of steps for grasping and monitoring the collection state, the conveyance state and the processing state of the waste;

FIG. 6 is comprised of FIGS. 6A, 6B and 6C showing diagrams for explaining one example of steps for grasping and monitoring the collection state, the conveyance state and the processing state of the waste; and

FIG. 7 is comprised of FIGS. 7A, 7B and 7C showing diagrams for explaining one example of steps for grasping and monitoring the collection state, the conveyance state and the processing state of the waste.

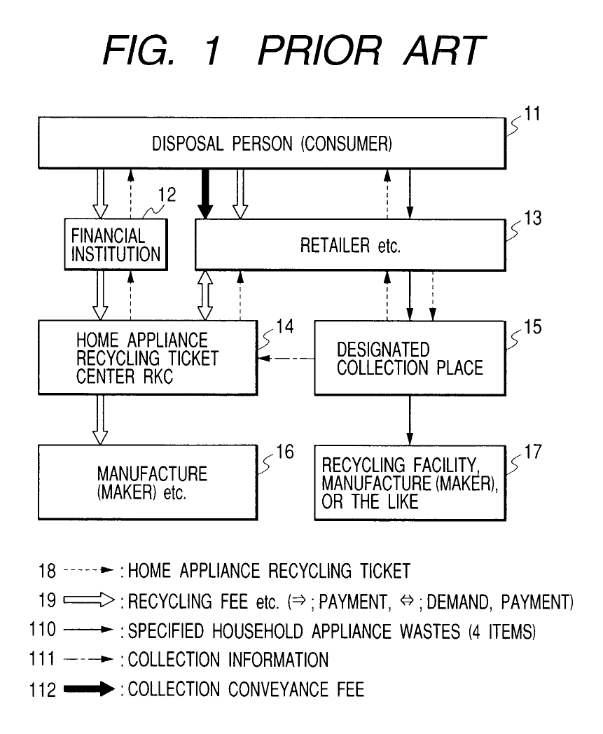

### DETAILED DESCRIPTION OF THE PREFERRED EMBODIMENT

An embodiment of a waste collection system of the present invention will hereinafter be described with reference to the accompanying drawings.

The discussion starts explaining wastes as collection objects in the following embodiments. The wastes collected by the waste collection system in this embodiment are preferably general wastes. It is preferable that the general waste is chosen from one category of at least electric products, electrical appliances, OA appliances, machines and precision instruments. The reason is that disposal persons conceived as objects in this embodiment are general consumers, and the embodiment relates to the efficient waste collection system in a case where a multiplicity of disposal persons dispose small amounts of general wastes. Supposing that the wastes are categorized as industrial wastes, the disposal persons are mainly entrepreneurs, and it is presumed in this case that a tremendous amount of wastes are disposed. It is therefore considered that a conveyance vehicle, which frequently collects the wastes from the entrepreneurs one after another, has a limit in terms of its load factor etc and is incapable of efficiently collecting the wastes. Accordingly, it may be said that the management of the wastes on an entrepreneur-by-entrepreneur basis is more efficient in the case of collecting the industrial wastes.

Still further, it is preferable that the wastes are electric products, the electrical appliances, the OA appliances, the machines an precision instruments among the general wastes. To be specific, these preferable wastes are TV systems, refrigerators, air-conditioners, washing machines, vacuum-cleaners, home electric appliances and products such as video cameras etc, and OA appliances such as personal computers, printers, displays etc.

This is because these electric products, electrical appliances, OA appliances, machines and precision instruments have a large number of recycling object parts and other parts containing toxic substances, and these parts need proper processing when disposed of. Further, the multiplicity of electric products, electrical appliances, OA appliances, machines and precision instruments spread in the general households, and amounts of the discharges thereof are large. Under such circumstances, it is indispensable to establish the waste collection system for collecting these wastes as recycling object products in terms of reducing the wastes at a landfill and effectively utilizing resources.

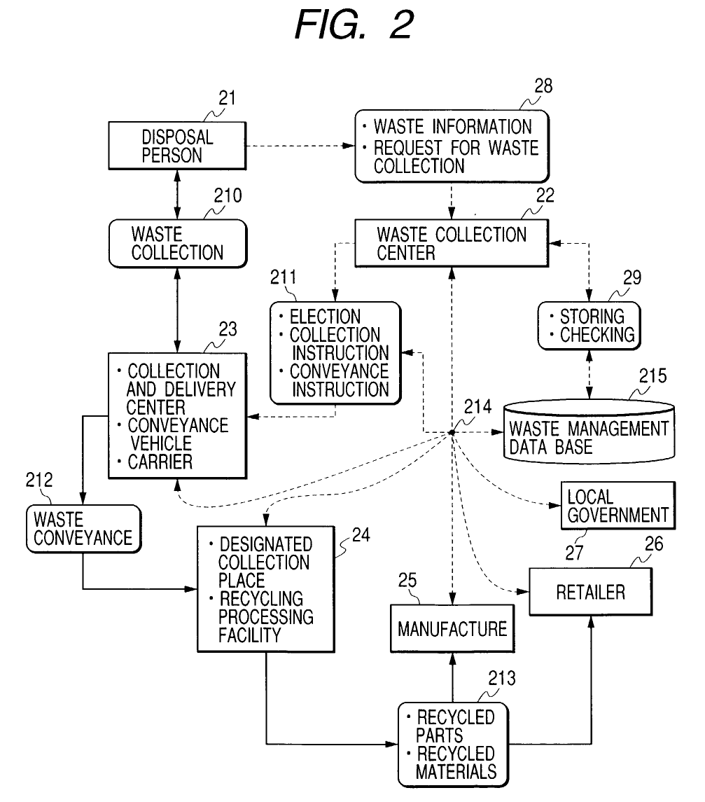

FIG. 2 is a schematic diagram showing one example of a waste collection method t which the waste collection system in this embodiment is applied.

Referring first to FIG. 2, an arrowhead of solid line indicates a flow of wastes, while an arrowhead of broken line indicates a flow of information. The waste collection method exemplified in FIG. 2 include the following steps.

Step 1: A disposal person 21 transfers pieces of waste collection application/waste information 28 to a waste collection center 22.

Step 2: The waste collection center 22 stored the waste information obtained from the disposal person in a waste management database 215, and makes a collation 29 with pieces of information in the waste management database 215.

Step 3: A collection and delivery center/conveyance vehicle/carrier 23 for collecting the wastes selected by the collation in step 2, is given an indication of a waste collection 210 and a waste conveyance 212.

Step 4: The collection and delivery center/conveyance vehicle/carrier 23 performs, based on the indication, the waste collection 210 from the disposal person. Further, the collection and delivery center/conveyance vehicle/carrier 23 carries out the waste conveyance 212 to a designated collection place/recycling processing facility 24.

Step 5: The wastes are processed in the recycling processing facility 24.

Step 6: Recycled parts/recycled materials 213 obtained by processing the wastes are delivered respectively to a manufacturer 25 and a retailer 26, and are recycled for materials of products.

Further, throughout all the steps, it is possible to grasp whether the wastes are properly processed and a present state thereof by configuring a network 214 including the waste management database 215, the waste collection center 22, the collection and delivery center/conveyance vehicle/carrier 23, the designated collection place/recycling processing facility 24, the manufacturer 25, the retailer 26 and a local government 27.

Herein, the waste collection system in this embodiment is constructed of first and second systems. The first system is defined as a waste collection system for determining a method of executing the waste collection 210 and the waste conveyance 212 on the basis of the waste information in steps 2, 3 and the waste management database 215.

The second system is defined as a waste collection system capable of, throughout all the steps, grasping and monitoring a collection state, a conveyance state and a processing state of the wastes in the network 214 networking with the waste management database 215.

Next, these first and second systems will be described in detail.

The discussion will be focused on, at first, the first system.

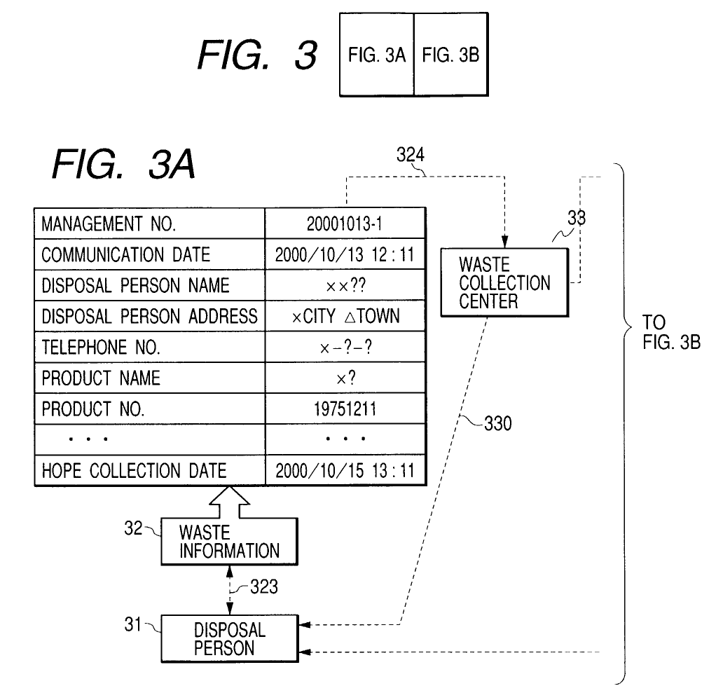

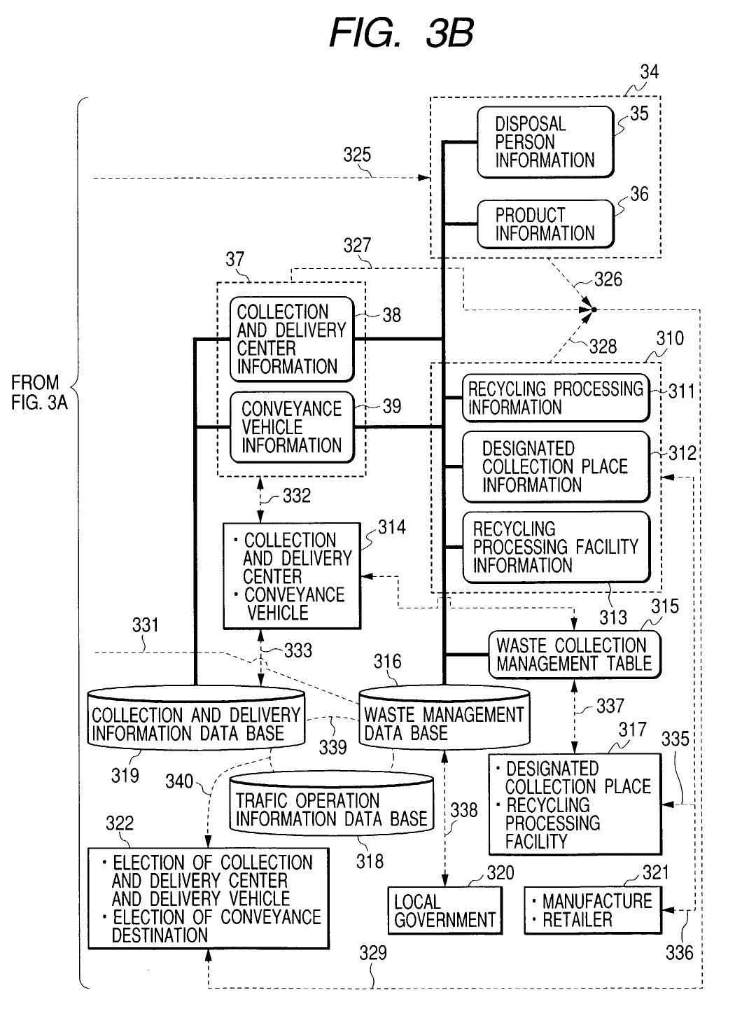

FIGS. 3A and 3B are conceptual diagrams showing one example of the waste collection system for determining the method of executing the waste collection 210 and the waste conveyance 212 on the basis of the waste information in steps 2, 3 and the waste management database 215.

To begin with, the disposal person 31 transmits the waste information to the waste collection center 33 by use of a communication means. At this time, the waste information 32 be, it is preferable, selected from at one category of at least disposal person information and product information of the waste. The reason why so is that these items of information are necessary for electing the collection and delivery center/conveyance vehicle 314 and/or the designated collection place/recycling processing facility 317 and for collecting the waste at a disposal place.

Further, it is preferable that the communication means be chosen from one category of at least a telephone line, an ISDN (Integrated Services Digital Network) circuit and a mobile phone circuit, and it is also preferable that a device for actualizing these communication means be selected from one category of at least a telephone, a facsimile device, a mobile phone, a personal computer and a TV system.

The disposal person 31 is, as described above, a general consumer, and it can be considered that the information communication means utilized by the general consumer involves the use of postal services. The postal services are not, however, a means for timely transmitting the waste information 32. On the other hand, the telephone line, the ISDN circuit and the mobile phone circuit spread widely over the general households and may be defined as superior means capable of timely and easily transmitting the waste information 32 as digital or analog information. Accordingly, the use of these communication means enables the general consumers to easily utilize the waste collection system in this embodiment and further the collection of the wastes to be promoted, thus exhibiting large effects.

Although there exist the multiple categories of devices for executing those communication means, the telephone, each household owns the facsimile device, the mobile phone, the personal computer and the TV system each, and hence it is preferable to utilize these devices.

What is specifically possible is an information transmission based on an interactive system using the facsimile device and the mobile phone or an information input/transmission (utilizing, e.g., DTMF [Dial Tone Multiple Frequency] signals and so on) by performing operations based on voice guidance etc, and the information can be transmitted by E-mail over the Internet as far as the use of the PC and TV system is concerned.

Especially the TV-based transmission system, with advancements of study and development of a broadcasting system using the digital system replacing the analog system over the recent years, launches into its utilization. Owing to this system, it is considered that the information transmission from the general consumer, which could not be attained by the broadcasting mode of the conventional one-way communication type, is facilitated via the TV system. Under such a circumstance that establishments of the TV system of the two-way communication type and of the broadcasting system utilizing this TV system, the TV system possessed by each household can be used in this embodiment, and hence the general consumer is led to deepen the recognition of the waste collection. Further, it is feasible to simultaneously attain a scheme of inspiring and promoting the activities required for building the recycling-oriented society targeting the recycling activities and the collection of the wastes.

Next, the waste information 32 transmitted to the waste collection center 33 from the disposal person 31 is stored in the waste management database 316 via the network.

At this time, the waste management database 316 preferably contains disposal person information 35, product information 36, collection and delivery center information 38, conveyance vehicle information 39, recycling processing information 311, designated collection place information 312, recycling processing facility information 313 and a waste collection management table 315 of the wastes. This is because the database 316 contains an information block (corresponding to the disposal person information/product information 34 in, e.g., FIGS. 3A and 3B) that structures the waste information 32, and an information block (corresponding to the collection and delivery center information/conveyance vehicle information 37 and the recycling processing information/designated collection place information/recycling processing facility information 310 in, e.g., FIGS. 3A and 3B) that structures the information for selecting the collection and delivery center/conveyance vehicle 314 and/or the designated collection place/recycling processing facility 317, whereby these items of information can be collated with the stored information given from the waste collection center 33. Moreover, the waste collection management table 315 is structured as an information block for using a result of the collation for newly collecting the wastes, thereby making it possible to facilitate grasping and monitoring the state of the waste collection.

Further, it is preferable that the following requirements be met in the respective items of information structuring the waste management database 316.

At first, the disposal person information 35 preferably contains at least a management number, a name of the disposal person, an address of the disposal person, a telephone number of the disposal person, a date of receipt and a hope collection date. It is because these items of information enable the waste disposal person 31 to be identified and a responsibility thereof to be clarified, and also become important position data when selecting the collection and delivery center/conveyance vehicle 314 and the designated collection place/recycling processing facility 317, and the hope collection date set therein leads to a consideration of a schedule of the disposal person 31, whereby a user-friendly system can be provided to the disposal person 31.

The product information 36 preferably contains a management number, a product name, a product number, a manufacturing year/month/date, a manufacturing serial number, a product weight and product dimensions. The reason is that these items of information are needed for collating the method of processing the wastes to be collected and the processing facility as well, and also become important data when selecting the collection and delivery center/conveyance vehicle 314 and the designated collection place/recycling processing facility 317. Further, the management of these items of information makes it possible to obtain useful pieces of information such as an amount of the products used on the market, an amount of disposal of those wastes, a period of time till the product is discarded and so forth. These pieces of information might become information (such as information for checking a life-time for developing the product and for promoting an environment-oriented product and so on) useful for the manufacturer, the retailer, the local government etc connected via the network.

The collection and delivery center information 38 preferably contains an address of the collection and delivery center, a telephone number of the collection and delivery center, a piece of information on the conveyance vehicle managed by the collection and delivery center and a state of preservation of the wastes at the collection and delivery center. This is because the collection and delivery center information 38, owing to the address of the collection and delivery center, become important data for selecting the collection and delivery center/conveyance vehicle 314 and the designated collation place/recycling processing facility 317, and the conveyance vehicle information and the information on the preservation state that are managed by the collection and delivery center at that time enable more efficient electing operation. To exemplify specifically, even at the collection and delivery center in closest proximity to the disposal place, if a waste preservation space has no allowance, or if the waste to be collected is special and is not treated at the collection and delivery center closest to the disposal place, it is possible to perform such a collation as to verify about the collection and delivery center that comes under the following category.

Further, it is necessary to pick out the conveyance vehicle (it is proper that a large-sized glass component is used and as in the case of, e.g., the TV system and requires a special caution in its handling, and, a conveyance vehicle equipped with a means for protecting the fragile article carries such a waste article) suited to transport this waste on the basis of the product information acquired from the waste information 32, and the conveyance vehicle corresponding to the condition can be collated based on the conveyance vehicle information managed by the collection and delivery center.

The conveyance vehicle information 39 preferably contains specifications of the conveyance vehicle, a driver of the conveyance vehicle, a vehicle number of the conveyance vehicle and an owner of the conveyance vehicle. The reason is that a state of the collection by the conveyance vehicle can be immediately confirmed by checking the conveyance vehicle for the waste and the driver of the conveyance vehicle, and further that an illegal disposal of the waste is prevented by clarifying the responsibility of the conveyance. Moreover, the specifications of the conveyance vehicle are defined as information needed for collecting the suited wastes, thereby enabling the high-level electing operation in the same way as the collection and delivery center information does.

The recycling processing information 311 preferably contains a product name, a product number, a name of manufacturer, a waste processing method, post-processing parts information and post-processing materials information. This is because these items of information need collating with the waste information 32 transmitted from the disposal person 31 and is needed to collate a due waste processing method, and further pieces of information after the recycling processing such as an amount of the parts, an amount of the material etc become the information, important to the manufacturer/retailer 321, about an inventory/purchase of the parts/materials used for their productions and so on.

The designated collection place information 312 preferably contains a name of the collection place, an address of the collection place, a telephone number of the collection place, treatment waste information at the designated collection place, a treatment waste preservation state at the designated collection place. The reason is that such items of information as the name of the collection place, the address of the collection place and telephone number of the collection place become the important data for electing the collection and delivery center/conveyance vehicle 314 and the designated collection place/recycling processing facility 317 and such items of information as the treatment waste information at the designated collection place and the treatment waste preservation state at the designated collection place are required for performing the efficient electing operation.

Similarly, the recycling processing facility information 313 preferably contains a name of the recycling processing facility, an address of the recycling processing facility, a telephone number of the recycling processing facility, processing object waste information at the recycling processing facility and processing object waste processing state at the recycling processing facility. As in the case of the designated collection place information 312, the reason is that the recycling processing facility information 313 contains the important data for efficiently electing the collection and delivery center/conveyance vehicle 314, the designated collection place/recycling processing facility 317.

The waste collection management table 315 is used for grasping and monitoring a state of the waste collection and a state of the conveyance thereof, and preferably contains a management number, product information, disposal person information, recycling processing information and a collection date. It is because the present state of the waste can be confirmed based on these items of information, and the information of the post-processing waste can be confirmed later on. Moreover, the waste collection management table 315 is created by re-structuring pieces of information stored on the waste management database 316 according to the waste collection center 33, the collection and delivery center/conveyance vehicle 314, the designate collection place/recycling processing facility 317, the manufacturer/retailer 321 and so on, and contains the items of information for managing the steps starting with collecting the waste by the conveyance vehicle and ending with finishing the processing of the waste.

The waste information 32 stored on the waste management database 316, based on a program created, through operations such as referring to or sorting out based on or inputting to the disposal person information/product information 34 and the waste collection management table 315, becomes information for electing the collection and delivery center/conveyance vehicle 314 and/or the designated collection place/recycling processing facility 317. Further, the collection and delivery center information/conveyance vehicle information 37 and the recycling processing information/designated collection place information/recycling processing facility information 310 are utilized as pieces of information for the selection thereof. The collection and delivery center information/conveyance vehicle information 37 consists of pre-registered information and realtime information, and hence some pieces of information are updated and inputted by the collection and delivery center/conveyance vehicle 314. The recycling processing information/designated collection place information/recycling processing facility information 310 likewise consists of pre-registered information and realtime information, and hence some pieces of information are updated and inputted at any time by the designated collection place/recycling processing facility 317.

A method capable of collecting and transporting most efficiently the waste discarded by the disposal person 31 by searching for the disposal person information/product information 34, the collection and delivery center information/conveyance vehicle information 37, the recycling processing information/collection place information/recycling processing facility information 319 by collating these items of information with the waste information 32 of the disposal person 31, is determined based on the waste management database 316.

Note that when searching for the disposal person information/product information 34, the collection and delivery center information/conveyance vehicle information 37, the recycling processing information/designated collection place information/recycling processing facility information 310 by collating these items of information with the waste information 32 of the disposal person 31, the collation and search via the network be, it is preferable, effected taking into consideration the information in the collection information database 319 containing the collection information about the collection and delivery center and/or the conveyance vehicle and the information in a traffic operation information database 318 containing pieces of information about traffic operations on the roads. The reason is that a more efficient waste collection method and a more efficient waste conveyance method can be determined by judging a state of the collection of the conveyance vehicle, a position thereof and a state of the road.

At this time, the collection information database 319 preferably contains a collection schedule of the on-collecting conveyance vehicle driving on the road, a state of the collection by the on-collecting conveyance vehicle, a position of the on-collecting conveyance vehicle, the collection and delivery center information 38 and the conveyance vehicle information 39. It is because the more efficient collection can be conducted in a way that takes the state of the collection by the on-collecting conveyance vehicle and the position information thereof into account, and further an error and a mistake in the result of the selection within the waste management database 316 can be reexamined. Herein, the collection schedule of the on-collecting conveyance vehicle and the state of the collection by the on-collecting conveyance vehicle consist of the information pre-registered by the collection and delivery center/conveyance vehicle 314 and the realtime information, and hence some pieces of information are updated and inputted at any time by the collection and delivery center/conveyance vehicle 314. Further, the position of the on-collecting conveyance vehicle can be detected by utilizing ITS (Intelligent Transport System), a GPS (Global Positioning System) satellite, a wireless network for business operations, a mobile phone network and so on.

Moreover, the traffic operation information database 318 preferably contains congested road information, traffic accident road information and required time information. The reason is that there might be a case in which the collecting operation can not be smoothly performed depending on a traffic condition even when the collection and delivery center/conveyance vehicle 314 capable of efficiently collecting the waste is elected. Accordingly, these causes are the traffic jam, the traffic accident etc that happen on the road, and the more efficient collection of the waste can be attained by electing the collection and delivery center/conveyance vehicle 314 in a way that takes into the consideration these pieces of information, the collection and delivery center/conveyance vehicle 314 and the required time spent up to the collection place.

The collection and delivery center/conveyance vehicle capable of efficiently collecting the waste can be thereby elected.

Further, the elected collection and delivery center/conveyance vehicle is given an indication to collect and/or to convey the waste via the network from the waste management database or by the waste collection center, while the disposal person is notified of a schedule date/time for collecting the waste that is chosen from one of at least the waste management database, the waste collection center, the collection and delivery center and the conveyance vehicle by use of a communication means. The conveyance vehicle for collecting the waste can not actually go collecting the waste to the disposal person till the transmission of those items of information is completed.

What has been discussed so far is one example of the waste collection system for electing the collection and delivery center/conveyance vehicle performing the waste collection 210 on the basis of the waste information and the waste management database 215.

Given next is a detailed description of the waste collection system capable of grasping and monitoring the collection state, the conveyance state and the processing state of the waste via the network 214 networking with the waste management database 215 throughout all the steps in the second system.

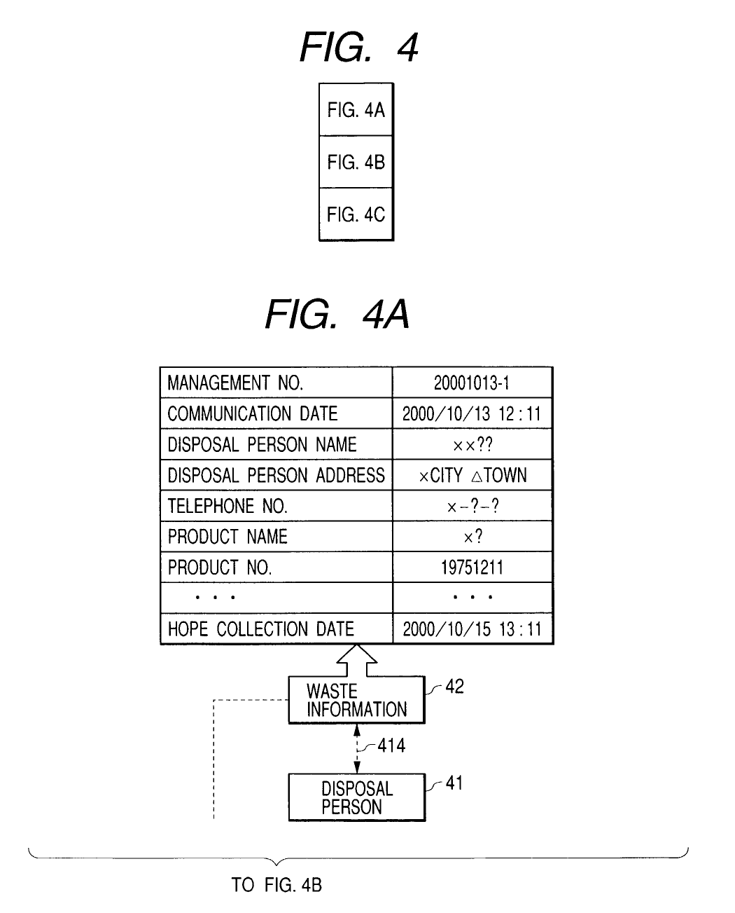

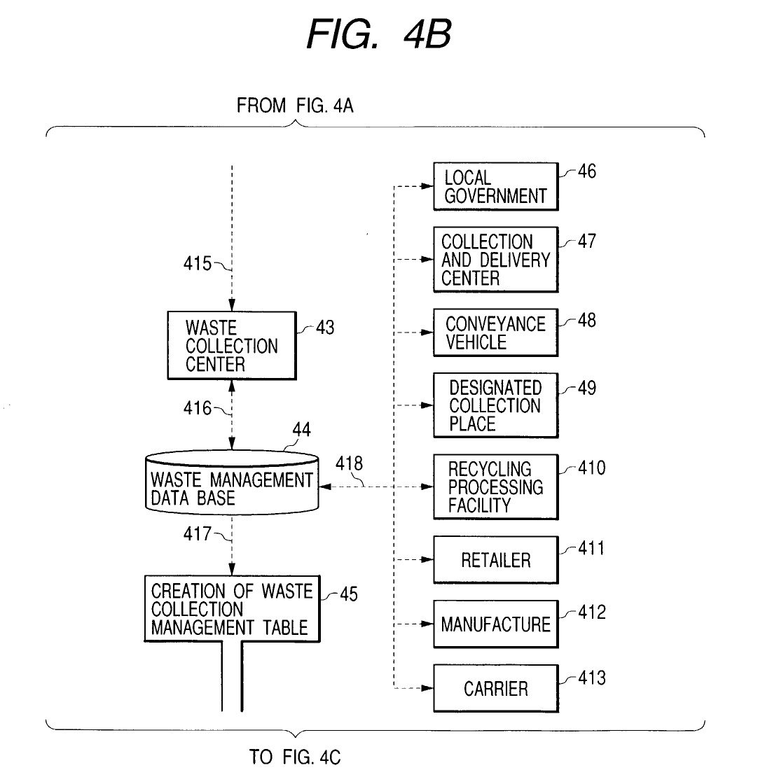

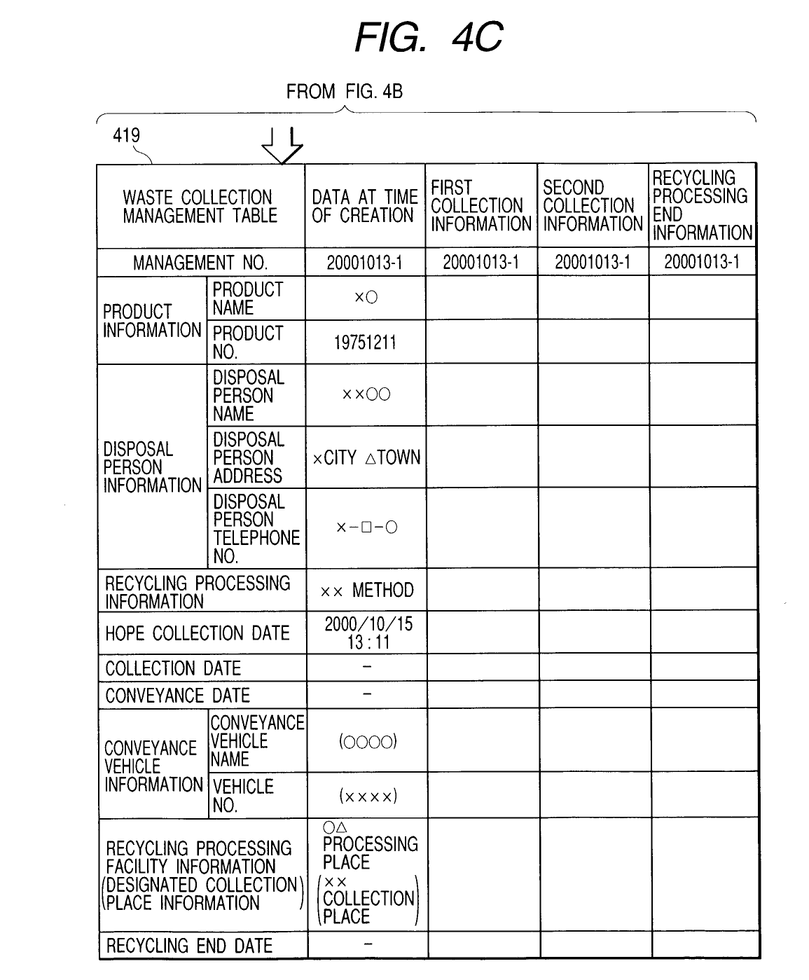

FIGS. 4A through 7C are diagrams showing one example of steps of grasping and monitoring the collection state, the conveyance state and the processing state of the waste, wherein the system in this embodiment is configured by what is selected from one of at least these steps.

To start with, the step exemplified in FIGS. 4A to 4C will be explained.

A disposal person 41 who disposes of the waste transmits waste information 42 to a waste collection center 43 via a communication means. At this time, it is preferable that the waste information 42 be chosen from one of at least the disposal person information of the waste and the product information. It is because these items of information become the information necessary for electing the collection and delivery center 47, the conveyance vehicle 48 and/or the designated collation place 49 and the recycling processing facility 410 and for collecting at the disposal place, and further make it possible to clarify the disposal person 41, a collecting person, a conveyance person, a preserver, a processing person of the waste and so forth.

Moreover, for the same reason as in the description of the first system, it is preferable that the communication means be selected from one category of at least the telephone line, the ISDN circuit, the mobile phone circuit, a PHS phone circuit, and it is also preferable that a device for executing these communication means be selected from one category of at least the telephone, the facsimile device, the mobile phone, the PHS phone, the personal computer and the TV system.

Next, the waste collection center 43 stores the transmitted waste information 42 on a waste management database 44 via the network and/or collates the information 42 with the database 44. At this time, for the same reason as in the discussion on the first system, it is preferable that the waste management database 44 be selected from one category of at least the disposal person information, the product information, the collection and delivery center information, the conveyance vehicle information, the recycling processing information, the designated collection place information, the recycling processing facility information and a waste collection management table 419 of the wastes. Similarly, it is preferable that the disposal person information among respective items of information structuring the waste management database 44, be selected from one item of at least a management number, a name of the disposal person, an address of the disposal person, a telephone number of the disposal person, a date of receipt and a hope collection date; the product information be selected from one item of at least a management number, a product name, a product number, a name of the manufacturer, a manufacturing year/month/date, a weight of product and dimensions of the product; the collection and delivery center information be selected from one item of at least an address of the collection and delivery center, a telephone number of the collection and delivery center, conveyance vehicle information managed by the collection and delivery center and a preservation state of the waste at the collection and delivery center; the conveyance vehicle information be selected from one item of at least specifications of the conveyance vehicle, a driver of the conveyance vehicle, a vehicle number of the conveyance vehicle and an owner of the conveyance vehicle; the recycling processing information be selected from one item of at least a name of the product, a product number, a name of the manufacturer, a waste processing method, post-processing parts information and post-processing materials information; the designated collection place information be selected from one item of at least a name of the designated collection place, and address of the designated collection place, a telephone number of the designated collection place treatment waste information of the designated collection place and a preservation state of the treatment waste at the designated collection place; and the recycling processing facility information be selected from one item of at least, a name of the recycling processing facility, an address of the recycling processing facility, a telephone number of the recycling processing facility, processing object waste information of the recycling processing facility and a processing state of the processing object waste at the recycling processing facility.

Further, it is preferable that the waste collection management table 419 be structured of one item selected among at least a management number, product information, disposal person information, recycling processing information, a collection date when the waste is collected from the disposal person, a conveyance date when the conveyance vehicle carries the waste to the designated collection place or the recycling processing facility, conveyance vehicle information, designated collection place information and recycling processing facility information. The reason is that the waste collection management table 419 is used for grasping and monitoring the collection state, the conveyance state and the processing state of the waste, and these items of information serve to know when, where and who disposes of, collects, carries and processes the waste, and also to know where the discarded waste is and what state the discarded waste exists. Further, it is also because the post-processing waste information can be confirmed later on.

Then, the waste information 42 stored on and/or collated with the waste management database 44 is used together with the data accumulated on the waste management database 44 to create (45) the waste collection management table 410 as shown in FIG. 4B in accordance with the structured program. At this time, various items of data are given as table creation data when creating the waste collection management table 410. For example, referring to FIGS. 4A to 4C, there are given the management number, the product information, the disposal person information, the recycling processing information, the hole collection date, the designated collection place information or the recycling processing facility information, these items of information are important data for collecting the waste, i.e., serve to clarify pieces of information for showing when, where and who disposes of, collects, carries and processes the waste, thereby clarifying the responsibilities of the person and the sector involved in processing the waste.

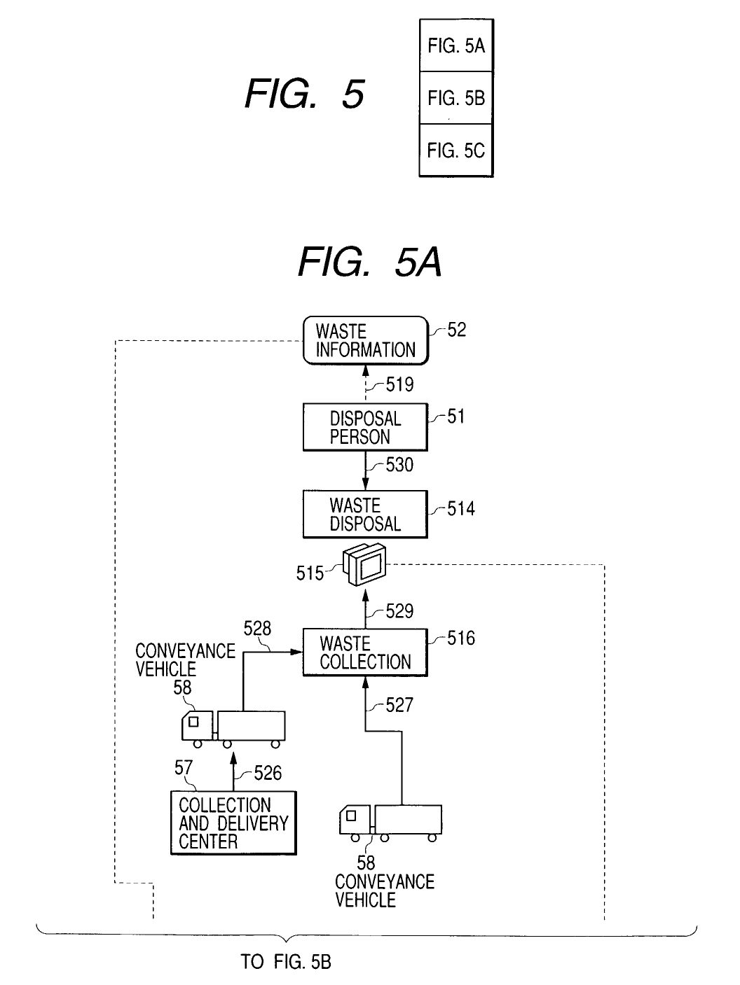

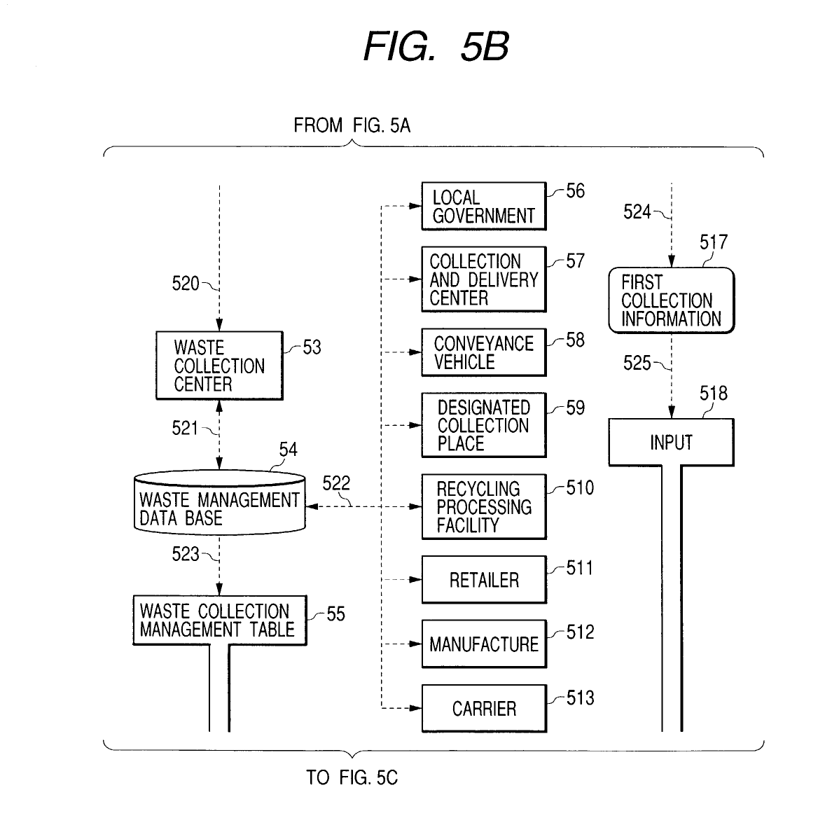

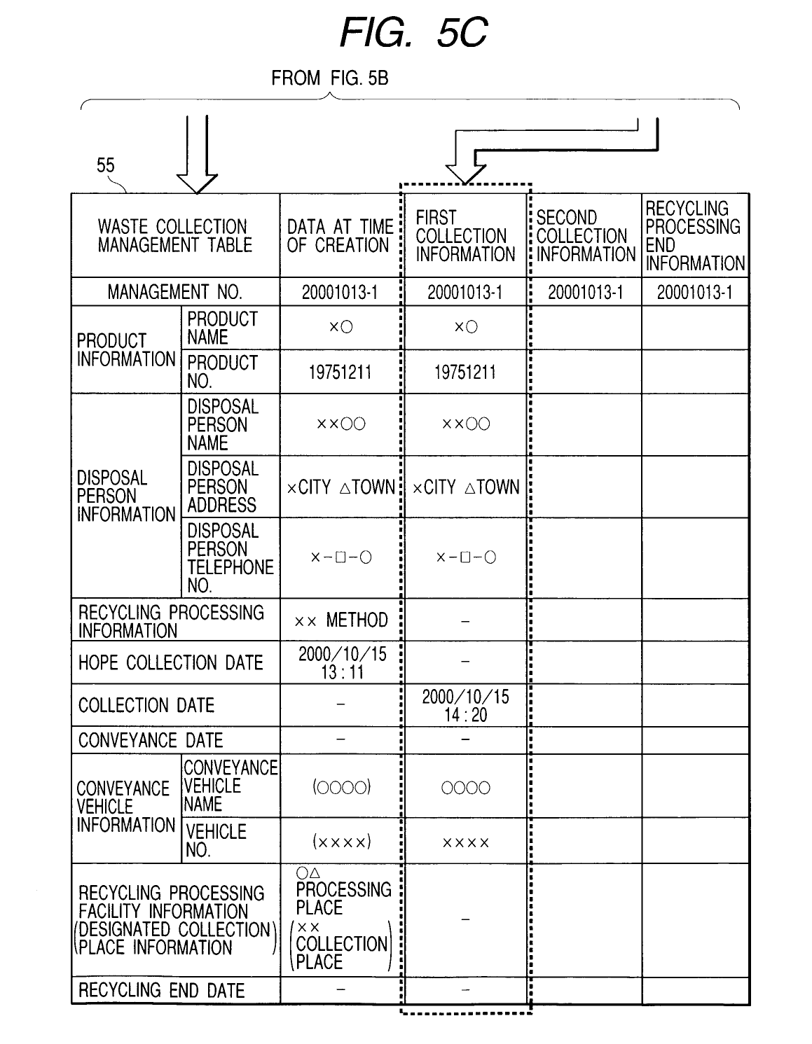

Next, the steps exemplified in FIGS. 5A to 5C will be explained.

A collection and delivery center 57 or a conveyance vehicle 58 for conducting a waste collection 516 goes collecting a waste 515 discarded by a disposal person 51 on the basis of the disposal person information given when creating a waste collection management table in a waste collection management table 55. Then, when collecting the waste 515 discarded by the disposal person 51, the collection and delivery center 57 or the conveyance vehicle 58 inputs first collection information 517 to the waste collection management table 55 within a waste management database 54. At this time, it is preferable that the first collection information 517 be selected from one item of at least the product information, the disposal person information, the collection date when collecting the waste from the disposal person, and the conveyance vehicle information. The reason is that the fact of having collected the waste is verified by inputting to the waste collection management table 55 the information that verifies who collects a waste, what waste is collected, when the waste is collected and whom the waste is collected from and where just when collecting the waste discarded by the disposal person 51, and further, the conveyance vehicle information being inputted, it can be made clear where the responsibility of treating the waste 515 exists thereafter.

Moreover, it is preferable that the waste 515 discarded be given an information storage means stored with the product information when delivering or manufacturing the product. Further, it is preferable that the first collection information be inputted in a way that inputs the product information through the information storage means. To be specific, the information storage means may be exemplified such as a barcode recording book, magnetic barcodes etc, and the product information stored therein is read for outputting by use of an information reading means such as a barcode reader etc, and then inputted to the waste collection management table 55. With this contrivance, the input/output of the information can be simplified, whereby the information can be efficiently transferred to the waste collection management table 55.

As discussed above, referring to FIG. 5, the first collection information 517 is inputted to the waste collection management table 55, whereby it is possible to verify who, what, when and whom the waste is collected by and to clarify where the responsibility of treating the waste 515 exists thereafter.

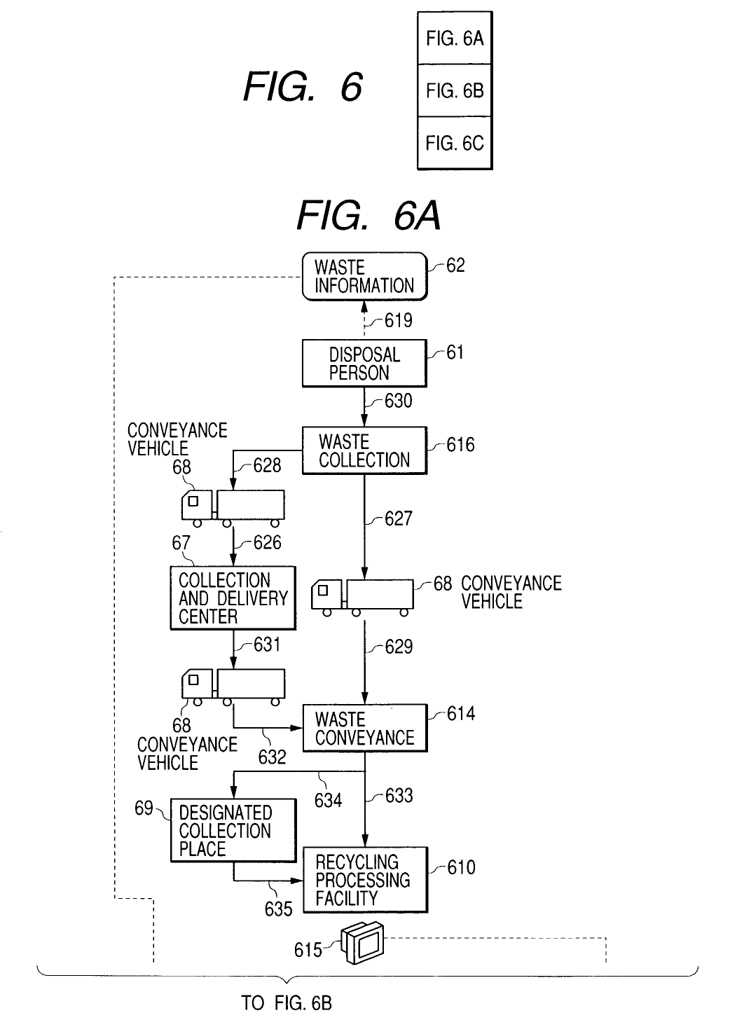

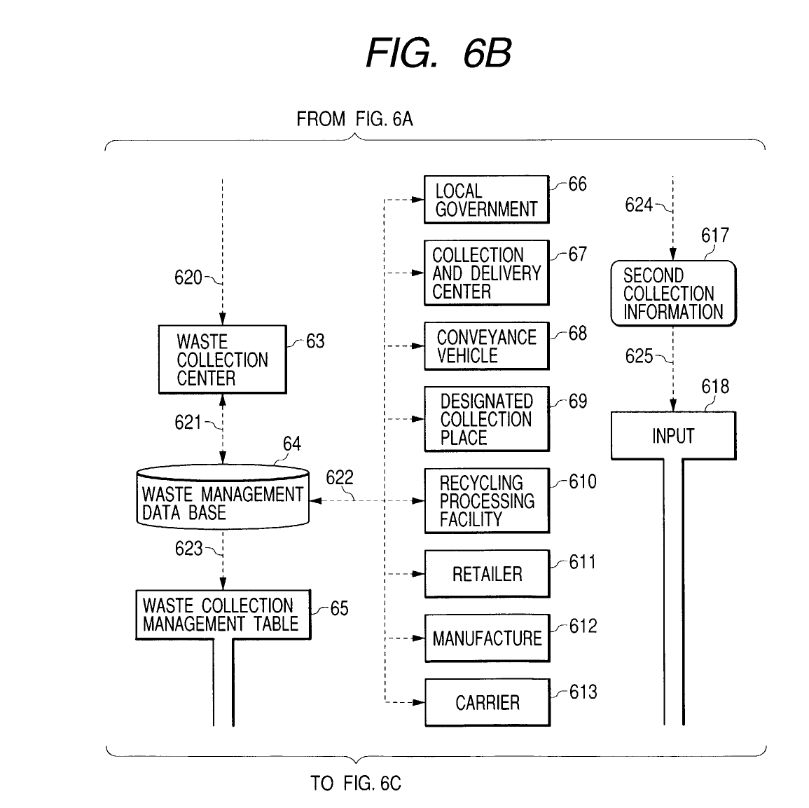

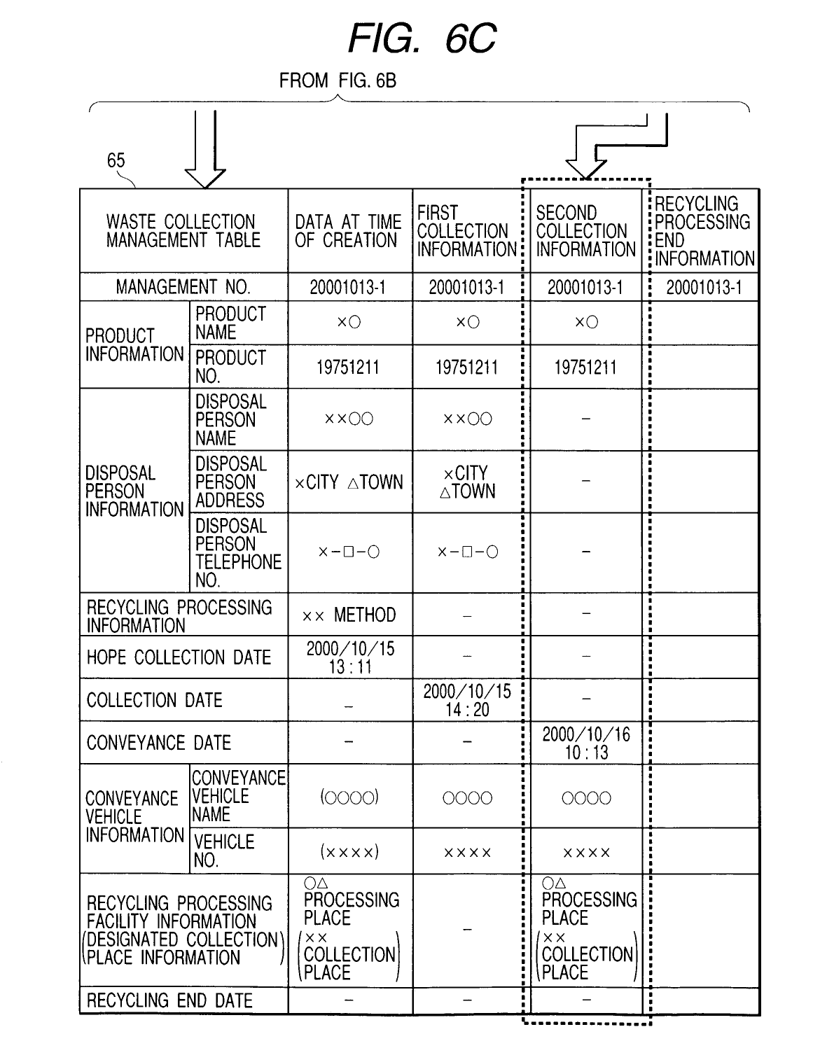

Next, steps exemplified in FIGS. 6A to 6C will be explained.

A collection and delivery center 67 or a conveyance vehicle 68 conducts a waste collection 616 of a waste 615 discarded by a disposal person 61, and the conveyance vehicle 68 performs a waste conveyance 614 on the basis of designated collection place information of recycling processing facility information inputted when creating a waste collection management table 65. When the conveyance vehicle 68 carries the waste 615 to a designated collection place 69 or a recycling processing facility 610, second collection information 617 is, as in the case of the first collection information, inputted to the waste collection management table 65 in a waste management database 64 by the conveyance vehicle 68 and the designated collection place 69 or the recycling processing facility 610.

At this time, it is preferable that the second collection information 617 be selected from one item of at least a product information, a conveyance date when the conveyance vehicle 68 carries the waste to the designated collection place 69 or the recycling processing facility 610, conveyance vehicle information, designated collection place information and recycling processing facility information. The reason is the fact of having conveyed the waste 615 to a due place is verified by inputting to the waste collection management table 65 the information that verifies who conveys a waste, what waste is conveyed, when the waste is conveyed and whom the waste is conveyed from and where the waste is conveyed to, and further, since the information showing that the waste 615 is finally processed is inputted, it can be made clear where the responsibility of processing the waste 615 exists thereafter.

Moreover, as in the explanation referring to FIGS. 5A to 5C, it is preferable that the waste 615 discarded be given an information storage means stored with the product information when delivering or manufacturing the product. Further, it is preferable that the second collection information be inputted in a way that inputs the product information through the information storage means.

As discussed above, referring to FIGS. 6A to 6C, the second collection information 617 is inputted to the waste collection management table 65, whereby it is possible to verify who, what, when and whom the waste is conveyed by and to clarify where the responsibility of treating the waste 615 exists thereafter.

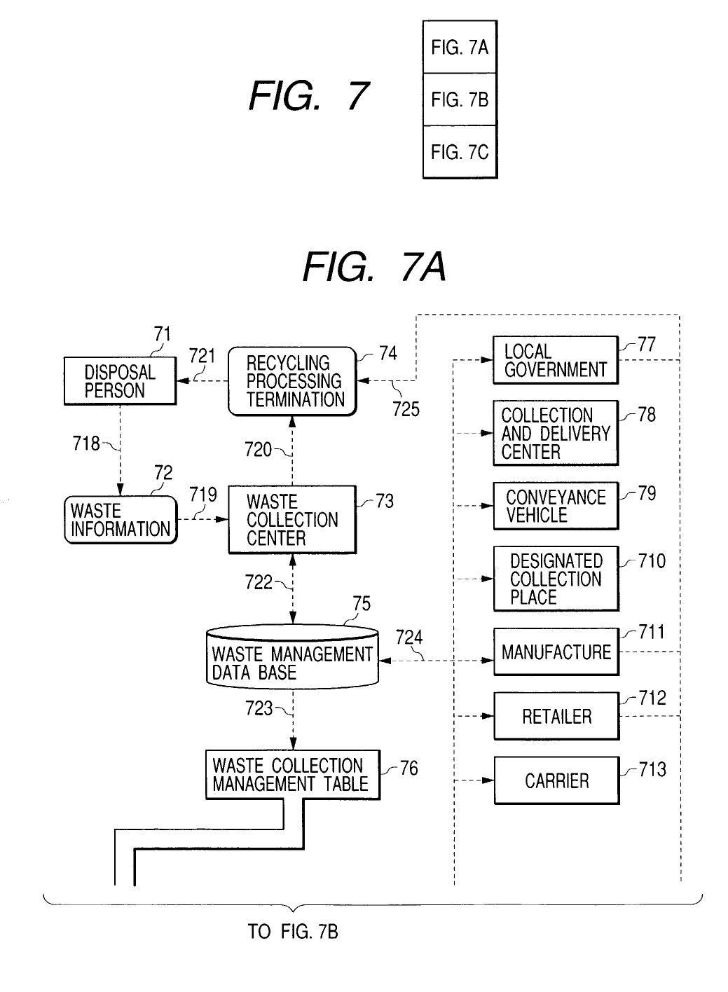

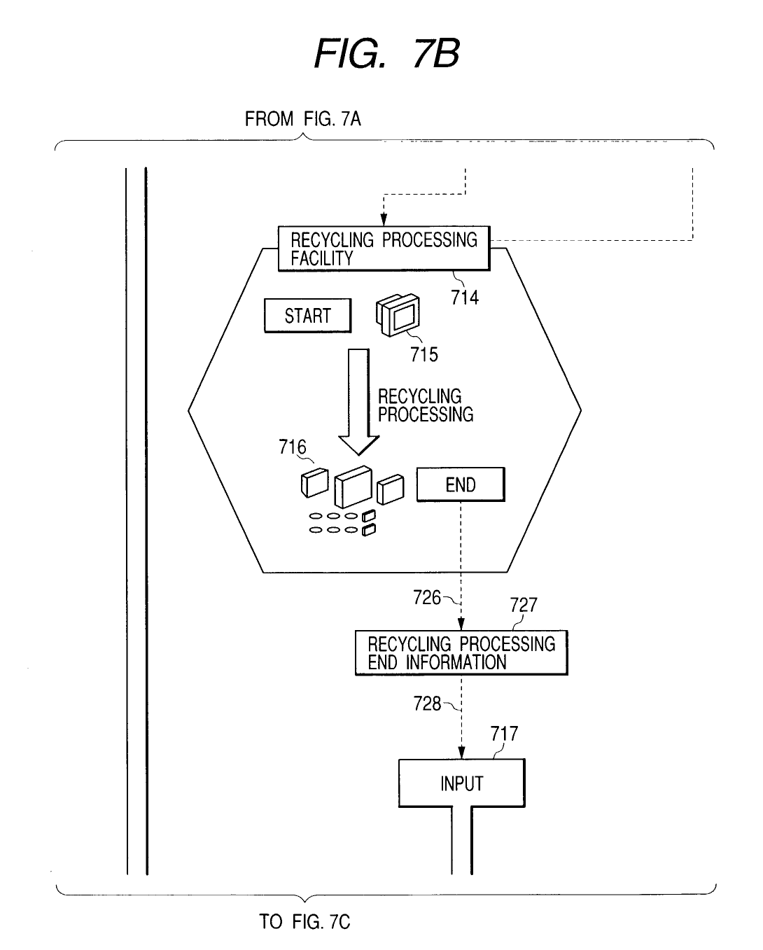

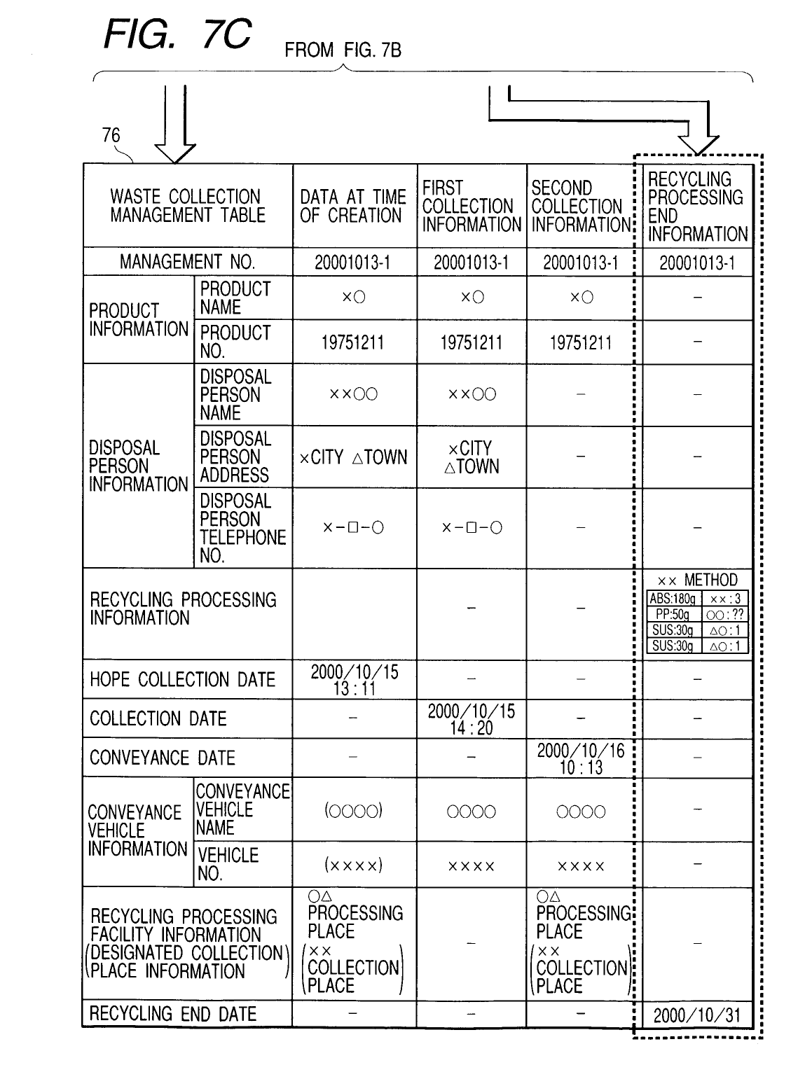

Next, steps exemplified in FIGS. 7A to 7C will be explained.

A waste 715 carried to a recycling processing facility 714 is decomposed by a designated processing method and processed into respective parts/materials 716 for recycling and reuse. Herein when finishing the processing at the recycling processing facility, recycling processing end information 727 is inputted into a waste management database 75.

At this time, it is preferable that the recycling processing information 727 be selected from one item of at least a recycling processing end date and recycling processing information. The reason is that the input of the recycling processing end date enables other related sectors to recognize the completion of the waste recycling processing. Further, the waste 715 is decomposed into the final parts/materials 716, and detailed pieces of information about the parts/materials 716, to be more specific, names of the parts, names of the materials, the numbers thereof and weights thereof are inputted as recycling processing information, whereby these pieces of information can be utilized as parts inventory information etc when reusing these parts/materials 716.

Moreover, after finishing the recycling processing, recycling processing end information 727 is inputted to the waste collection management table 76, and, when finishing the recycling processing of the waste 715, one party selected from at least a waste collection center 73, a recycling processing facility 714, a manufacturer 711, a retailer 712 and a local government 77 recognizes a completion of collecting the waste discarded by the disposal person 71 and a completion of the recycling processing from pieces of information in the waste collection management table 76 and the waste management database 75, and transmits the completion of the waste collection and the completion of the recycling processing to the disposal person 71 via the communicating means described above. With this contrivance, it can be confirmed what process the waste 71 discarded by the disposal person 71 is processed in and when the recycling processing is finished. Further, the processing of the waste discarded by the disposal person 71 himself or herself can be clearly confirmed, and hence the disposal person 71 is prompted to enhance awareness of recycling and is able to monitor the recycling processing by himself or herself.

As discussed above, referring to FIGS. 7A to 7C, the recycling processing end information 727 is inputted to the waste collection management table 76, thereby making it possible to finally confirm that the waste 715 disposed of has undergone the due processing, and to know what kind of parts/materials 716 the waste 715 has been decomposed into.

Moreover, the disposal person 71 can confirm the end of the final processing of the waste 715.

Thus, the system configured by the steps exemplified as shown in FIGS. 4A through 7C is provided, thereby making it feasible to prevent illegal ad unlawful actions such as the illegal disposal, illegal selling etc and to efficiently grasp and monitor the collection state, the conveyance state and the processing state of the waste. Ideally, it is more preferable that the system be configured by all the steps. This is because the collection state, the conveyance state and the processing state of the waste can be checked at every stage and can be thereby grasped and monitored more effectively.

Further, in the case of separately collecting a recycling fee from the consumer, the recycling fee can be efficiently collected by utilizing the second system in this embodiment. To be specific, the system is such that the waste information and/or the waste collection management table contain(s) E-commerce information (e.g., a credit card number, a cash card number etc) of the disposal person, the disposal person is charged a fee for recycling on the basis of the E-commerce information, and the fee is drawn from a disposal person's own bank account specified. This system eliminates manual cash paying/receiving steps throughout the respective steps in a cost processing method for the costs occurred during a flow of collecting and processing the waste, and these manual steps are automatically and electronically processed, thereby making it possible to reduce the human cost and load as well and to configure an efficient accounting system.

The present embodiment related to the first system and the second system has been discussed so far, however, it is desirable that the following requirements about these two system be satisfied.

Namely, it is preferable that the waste collection center is constructed of one single body or a composite body of at least the manufacturer, the retailer, the transportation agency and the local government. The reason is that a business agency or an organization managing the collection of the waste consists of a business agency or an organization involved in the waste collection system, thereby facilitating sharing of the useful information for collecting the waste. A further reason is that the society is demanded to strongly promote the recycling activities, and it is of importance to take the action for collecting the wastes in a broader framework than the business circles, the enterprises and the local governments.

For the same reason, it is preferable that the collection and delivery center be constructed of one single body or a composite body of at least the manufacturer, the retailer, the transportation agency and the local government. It is also preferable that the designated collection place be constructed of one single body or a composite body of at least the manufacturer, the retailer, the transportation agency, the waste processing business agency and the local government. Further, it is preferable that the recycling processing facility be constructed of one single body or a composite body of at least the manufacturer, the retailer, the transportation agency, the waste processing business agency and the local government.

Moreover, it is preferable that the conveyance vehicle be selected from one category of at least a home delivery vehicle and a home delivery service. The reason is that the home delivery vehicles and the home delivery services are defined as an well-prepared infrastructure for the physical distribution, wherein a multiplicity of home delivery vehicles run on the roads and the home delivery services are conducted through on the roads daily. Then, these home delivery vehicles are applied to the waste conveyance vehicles which daily visit the general homes without utilizing a new physical distribution infrastructure, thereby yielding advantages such as (1) starting up the system at a early stage, (2) reducing the costs for the system by eliminating the necessity of utilizing the physical distribution infrastructure and (3) facilitating acceptance of the general consumers by utilizing the vehicles that daily visit the general homes.

Further, it is preferable that the collection and delivery center has the function of the waste collection center. The reason is that the waste collection center deals with the information such as the waste information etc, while the collection and delivery center manages the waste collection vehicle, whereby it is possible to omit a futility by unifying the working contents of the two centers and to configure the more efficient waste collection system.

Further, it is preferable that the recycling processing facility be the designated collection place. For instance, in the case of collecting the waste in a solitary island and an area where the processing facility is installed at a far distance, the conveyance vehicle carries the waste to the recycling processing facility each time. This transportation is time- and fuel-consuming and non-efficient. It is more efficient to provide the designated collection place and carry a certain amount of wastes batchwise. If a distance from a waste collecting spot to the designated collection place is farther then a distance to the recycling processing facility, however, the conveyance to the recycling processing facility is more efficient than the conveyance to the designated collection place, and there is no problem if the recycling processing facility serves as the designated collection place.

The waste collection system in this embodiment has been described in detail so far on the basis of the specific waste collection method, however, the present embodiment and the waste collection method using the present embodiment are not absolutely limited to the specific embodiments given above and can be changed in a variety of forms within the range of the gist thereof.

There is no prior art that established the waste collection method. The waste collection methods proposed at the present time have such a problem that the consumer and the disposal person each have a large burden, and there are neither yet approaches to the collection requests of the consumer and the disposal person, a problem about the preservation of a retailer shop nor any scheme of corresponding to a variety of waste product groups. According to the present embodiment, however, it is possible to attain the waste collection capable of flexibly corresponding to a variety of events. Specifically, it is feasible to promptly respond to the collection request from the individual disposal person, and the scheme of networking of the information for efficiently collecting the waste can be actualized, whereby the waste efficient collection system configured to restrain the futile costs caused by the recycling processing can be provided.

It is also possible to provide the waste collection system for effectively preventing the illegal disposal and illegal selling of the wastes, which are the social problems and to promote the recycling structure in the society by carrying out the present embodiment.

What is claimed is:

1. A waste collection system for collecting a waste, comprising:
a terminal of a waste collection center for managing at least information about a waste to be collected;
a terminal of a collection and delivery center for managing a conveyance vehicle for collecting the waste;
a terminal of said conveyance vehicle for collecting the waste;
a terminal of a designated collection place for receiving the waste; and
a terminal of a recycling processing facility for processing the waste, said terminals sharing a waste management database with each other via a network, said waste management database containing the information about the waste,
said terminal of said waste collection center, including:
recognition means for recognizing that a disposal person who disposes of the waste transmits the waste information by use of communication means; and
storage collation means for storing the waste information in said waste management database and/or collating the waste information with said waste management database,
wherein said collection and delivery center for collecting the waste, said conveyance vehicle and said designated collection place or said recycling processing facility to which said conveyance vehicle carries the waste, are selected within said waste management database.

2. A waste collection system according to claim 1, wherein a schedule date for collecting the waste is transmitted to said disposal person from what is selected from one of at least said waste management database and said terminals of said waste collection center, said collection, said delivery center and said conveyance vehicle.

3. A waste collection system according to claim 1, wherein said waste is one of at least an electric product, an electrical appliance, an OA appliance product, a machine product, and a precision instrument product.

4. A waste collection system according to claim 1, wherein said disposal person information contains at least a management number, a name of said disposal person, an address of said disposal person, a telephone number of said disposal person, a date of receipt and a hope collection date.

5. A waste collection system according to claim 1, wherein said product information contains one of at least the management number, a name of product, a product number, a name of manufacturer, a manufacturing year/month/date, a manufacturing number, a weight of product and product dimensions.

6. A waste collection system according to claim 1, wherein said recycling processing information contains one of at-least of the name of product, the product number, the name of manufacturer, a waste processing method, post-processing parts information and post-processing materials information.

7. A waste collection system for collecting a waste, comprising:
a terminal of a waste collection center for managing at least information about a waste to be collected;
a terminal of a collection and delivery center for managing a conveyance vehicle for collecting the waste;
a terminal of said conveyance vehicle for collecting the waste;
a terminal of a designated collection place for receiving the waste; and
a terminal of a recycling processing facility for processing the waste, said terminals sharing a waste management database with each other via a network, said waste management database containing the information about the waste,
wherein said terminal of said waste collection center, includes storage collation means for storing waste information in said waste management database and/or collating the waste information with said waste management database in order to create a waste collection management table,
said terminal of said collection and delivery center or said conveyance vehicle, includes first input means for inputting first collection information of the waste to said waste collection management table when collecting said waste,
one terminal selected among said terminals of at least said conveyance vehicle, said designated collection place and said recycling processing facility, includes second input means for inputting second collection information of said waste to said waste collection management table when said conveyance vehicle carries said waste to said designated collection place or said recycling processing facility, and
said terminal of said recycling processing facility includes third input means for inputting recycling processing end information to said waste collection management table when finishing the recycling processing of said waste.

8. A waste collection system according to claim 7, wherein said waste is one of at least an electric product, an electrical appliance, an OA appliance product, a machine product, and a precision instrument product.

9. A waste collection system according to claim 7, wherein said first collection information contains one of at least the product information, the disposal person information, a collecting date when collecting said waste from said disposal person, and the conveyance vehicle information.

10. A waste collection system according to claim 7, wherein the recycling processing end information contains one of at least a recycling processing end date and recycling processing information.

11. A waste collection system according to claim 7, wherein the conveyance vehicle information contains one of at least specification of said conveyance vehicle, a drive of said conveyance vehicle, a vehicle number of said conveyance vehicle and an owner of said conveyance vehicle.

12. A waste collection system according to claim 7, wherein the recycling processing information contains one of at least the name of product, the product number, the name of manufacturer, the waste processing method, the post-processing parts information and the post-processing materials information.

13. A waste collection method in a system comprising:
a terminal of a waste collection center for managing at least information about a waste to be collected;
a terminal of a collection and delivery center for managing a conveyance vehicle for collecting the waste;
a terminal of said conveyance vehicle for collecting the waste;
a terminal of a designated collection place for receiving the waste; and
a terminal of a recycling processing facility for processing the waste, said terminals sharing a waste management database with each other via a network, said waste management database containing the information about the waste,
said terminal of said waste collection center, including:
a recognition step of recognizing that a disposal person who disposes of the waste transmits the waste information by use of communication means; and
a storage collation step of storing the waste information in said waste management database and/or collating the waste information with said waste management database,
wherein said collection and delivery center for collecting the waste, said conveyance vehicle and said designated collection place or said recycling processing facility to which said conveyance vehicle carries the waste, are selected within said waste management database.

14. A waste collection method in a system comprising:
a terminal of a waste collection center for managing at least information about a waste to be collected;
a terminal of a collection and delivery center for managing a conveyance vehicle for collecting the waste;
a terminal of said conveyance vehicle for collecting the waste;
a terminal of a designated collection place for receiving the waste; and
a terminal of a recycling processing facility for processing the waste, said terminals sharing a waste management database with each other via a network, said waste management database containing the information about the waste,
wherein said terminal of said waste collection center, includes a storage collation step of storing waste information in said waste management database and/or collating the waste information with said waste management database in order to create a waste collection management table,
said terminal of said collection and delivery center or said conveyance vehicle, includes a first input step of inputting first collection information of the waste to said waste collection management table when collecting said waste,
one terminal selected among said terminals of at least said conveyance vehicle, said designated collection place and said recycling processing facility, includes a second input step of inputting second collection information of said waste to said waste collection management table when said conveyance vehicle carries said waste to said designated collection place or said recycling processing facility, and
said terminal of said recycling processing facility includes a third input step of inputting recycling processing end information to said waste collection management table when finishing the recycling processing of said waste.
